(19) United States
(12) Patent Application Publication
(10) Pub. No.: US 2020/0171548 A1
(43) Pub. Date: Jun. 4, 2020

(54) AUTOMATIC LOGISTICS SORTING SYSTEM AND AUTOMATIC LOGISTICS SORTING METHOD

(71) Applicant: BEIJING GEEKPLUS TECHNOLOGY CO., LTD., Chaoyang District, Beijing (CN)

(72) Inventors: Jianbei LI, Beijing (CN); Zheng WANG, Beijing (CN); Jun LIU, Beijing (CN)

(21) Appl. No.: 16/621,467

(22) PCT Filed: Dec. 12, 2017
(86) PCT No.: PCT/CN2017/115748

§ 371 Date: Dec. 11, 2019

(30) Foreign Application Priority Data
Sep. 30, 2017 (CN) 201710922993.1
Sep. 30, 2017 (CN) 201710938309.9

(51) Int. Cl. B07C 3/00; B07C 3/02

(52) U.S. Cl. CPC B07C 3/006; B07C 2501/0063; B07C 3/02

(57) ABSTRACT

Provided are an automatic logistics sorting system and method having a mechanism for automatically processing an abnormal item. The automatic logistics sorting system includes an automatic transport unit, a sorting area, and a control system. The control system includes a setting unit, a determining unit, and a control unit. By adopting the mechanism for automatically processing the abnormal item, high-efficiency item sorting is achieved.

### CROSS-REFERENCE TO RELATED APPLICATIONS

This is a U.S. National Stage Application of International Patent Application No. PCT/CN2017/115748, filed on Dec. 12, 2017, which claims priority to Chinese Patent Application No. 201710922993.1, filed on Sep. 30, 2017, and to Chinese Patent Application No. 201710938309.9, filed on Sep. 30, 2017, the contents of which are incorporated herein by reference in their entireties.

### TECHNICAL FIELD

The present application relates to automatic logistics, and more particularly relates to an automatic logistics sorting system and method having a mechanism for automatically processing an abnormal item.

### BACKGROUND

The rapid development of e-commerce has not only brought unprecedented development opportunities to the express delivery industry, but also presented serious challenges to express services. How to efficiently, flexibly, and accurately sort packages with a low cost has long been a difficult problem for the industry. The traditional manual matrix sorting faces various problems, such as low efficiency, high error rate, heavy labor intensity, employee recruitment difficulty, and management difficulty. The traditional automatic sorting device such as a cross-belt sorter mainly faces problems of huge investment, slow return, and poor flexibility and scalability. In terms of equipment utilization rate, it cannot meet change requirements of peaks and valleys in various periods. Furthermore, the cross-belt sorter is a serial system, such that a fault in one point on the main line will cause the entire cross-belt sorting system to stop working. Therefore, the flexible automatic package sorting has become a key issue and an urgent demand for the development of the express industry.

In recent years, the vigorous development of robot technologies has brought huge technological changes to the entire logistics industry, and brought new technologies and new design concepts to the sorting industry. FIG. 1 is a schematic diagram of an exemplary existing automatic logistics sorting system using robots. As shown in FIG. 1, the automatic logistics sorting system adopts a form of “robot plus steel platform”. An operator places a package on a robot carrying device at an item supplying stand, and then the robot carries the package to a position of a steel item dropping opening and drops the package into the item dropping opening, thus completing the package sorting task.

The above-mentioned automatic logistics sorting system greatly improves the sorting efficiency compared with the traditional manual sorting method, and has advantages of low costs and high flexibility compared with the traditional automated method such as the cross-belt sorter. Therefore, such a system has gained wide attention and has been rapidly popularized in the industry.

In the above-mentioned automatic logistics sorting system, after the package is placed on the robot carrying device, the robot carrying device will first pass through a package inspection device to confirm that the package needs to be transported to the item dropping opening. At this moment, however, if the package inspection device fails to detect a corresponding item dropping opening from the package, for example, from an express sheet on the package, then the package sorting will go abnormal.

Regarding such a package abnormality, the existing method typically would remove the package from the robot or directly remove the robot from the platform. No matter which processing method is adopted, however, the processing of the abnormal package will affect the subsequent logistics sorting process. In other words, only after the abnormal package is processed can the normal logistics sorting process be continued.

Therefore, there is a need for an improved automatic logistics sorting solution.

### SUMMARY

In view of the above-mentioned drawbacks and deficiencies of the related art, it is one object of the present application to provide a novel and improved automatic logistics sorting system and method having a mechanism for automatically processing an abnormal item.

According to an aspect of the present application, an automatic logistics sorting system is provided, which includes: an automatic transport unit, which is configured to transport an item to be sorted; a sorting area, which is configured to allow the automatic transport unit to operate therein to implement sorting of the item to be sorted, where the sorting area includes an item dropping area that includes a plurality of sorting target objects, and the automatic transport unit is configured to drop the item to be sorted into a corresponding sorting target object in the item dropping area; and a control system, which is configured to control the sorting of the item to be sorted and movement of the automatic transport unit in the sorting area, the control system including: a setting unit, which is configured to set a specific sorting target object among the plurality of sorting target objects for abnormality processing; a determining unit, which is configured to determine whether the item to be sorted is abnormal; and a control unit, which is configured to, in response to determining that the item to be sorted is abnormal, control to transport the item to be sorted to the specific sorting target object for the abnormality processing.

In the above automatic logistics sorting system, the sorting area further includes: an item supplying area, which is configured to distribute the item to be sorted, and a transport area, which is configured to allow one or more of the automatic transport unit to move therein, where the one or more automatic transport units are configured to transport the item to be sorted to pass through the transport area. The transport area and the item dropping area are located on the same plane and do not overlap.

In the above automatic logistics sorting system, the control system further includes at least one selected from the group consisting of the following: a first processing unit, which is configured to process an abnormal item in the item supplying area; or a second processing unit, which is configured to process the abnormal item in the specific sorting target object for abnormality processing.

In the above automatic logistics sorting system, the determining unit is configured to determine whether the item to be sorted has no corresponding sorting destination information, and the second processing unit is configured to re-determine a sorting destination of the item to re-sort the item.

In the above automatic logistics sorting system, the determining unit is configured to determine that corresponding item information of the item to be sorted does not have a sorting destination corresponding to the item information; determine whether the item to be sorted has not recorded the item information relating to the corresponding sorting destination; or determine whether the item information recorded on the item to be sorted is unidentifiable.

In the above automatic logistics sorting system, the determining unit is configured to determine whether the item to be sorted has a plurality of pieces of corresponding sorting destination information; and the second processing unit is configured to record abnormality information of the item to be sorted, and identify one of the plurality of pieces of sorting destination information of the item to be sorted to re-sort the item.

In the above automatic logistics sorting system, the setting unit is further configured to determine a number of specific sorting target object configured for the abnormality processing and/or positions of the specific sorting target objects for the abnormality processing in the item dropping area based on quantitative proportions of items to be sorted corresponding to different sorting target objects.

In the above automatic logistics sorting system, the plurality of sorting target objects correspond to moveable containers configured for containing sorted items.

According to another aspect of the present application, an automatic logistics sorting method is provided, which includes: placing one or more items to be sorted on an automatic transport unit in an item supplying area; obtaining item related information of the one or more items to be sorted, where the item related information includes abnormality information of the one or more items to be sorted; setting an abnormality sorting target object for abnormality processing; determining a specific sorting target object corresponding to the one or more items to be sorted based on the item related information, where the one or more items to be sorted having the abnormality information correspond to the abnormality sorting target object for the abnormality processing; carrying, by the automatic transport unit, the one or more items to be sorted to pass through a transport area, where the one or more items to be sorted having the abnormality information are transported to the abnormality sorting target object for abnormality processing; and moving, by the automatic transport unit, to an item dropping area, and dropping the one or more items to be sorted to a corresponding specific sorting target object.

In the above automatic logistics sorting method, the transport area and the item dropping area are located on the same plane and do not overlap.

In the above automatic logistics sorting method, the method further includes performing a first processing on an abnormal item in the item supplying area; and/or performing a second processing on the abnormal item in the specific sorting target object for the abnormality processing.

In the above automatic logistics sorting method, the abnormality information of the one or more items to be sorted includes that the one or more items to be sorted do not have corresponding sorting destination information, and performing the second processing on the abnormal item includes re-determining a sorting destination of the item to re-sort the item.

In the above automatic logistics sorting method, that the one or more items to be sorted do not have the corresponding sorting destination information includes: that corresponding item information of the one or more items to be sorted does not have a sorting destination corresponding to the item information; that the one or more items to be sorted do not record the item information relating to the corresponding sorting destination; or that the item information recorded on the one or more items to be sorted is unidentifiable.

In the above automatic logistics sorting method, the abnormality information of the one or more items to be sorted includes that the one or more items to be sorted have a plurality of pieces of corresponding sorting destination information, and performing the second processing on the abnormal item includes: recording the abnormality information of the one or more items to be sorted; and identifying one of the plurality of pieces of sorting destination information of the one or more items to be sorted to re-sort the one or more items to be sorted.

In the above automatic logistics sorting method, setting the abnormality sorting target object for the abnormality processing includes: determining the number of abnormal sorting objects for the abnormality processing and/or positions of the abnormal sorting objects for the abnormality processing in the item dropping area based on quantitative proportions of the one or more items to be sorted corresponding to different sorting target objects.

In the above automatic logistics sorting method, the sorting target objects correspond to moveable containers configured for containing sorted items.

According to another aspect of the present application, an automatic logistics sorting system is provided. The automatic logistics sorting system includes: an automatic transport unit, which is configured to transport an item to be sorted; a sorting area, which is configured to allow the automatic transport unit to operate therein to implement sorting of the item to be sorted; and a control system, which is configured to control the sorting of the item to be sorted and movement of the automatic transport unit in the sorting area, the control system including: a detecting unit, which is configured to detect a state of the automatic transport unit; a determining unit, which is configured to determine a state type of the automatic transport unit; and a control unit, which is configured to, in response to determining that the automatic transport unit is in a first state type where an automatically fixable fault occurs, control the automatic transport unit to automatically fix the fault.

In the above automatic logistics sorting system, the determining unit is further configured to, in response to determining that the automatic transport unit is not in the first state type where the automatically fixable fault occurs, determine whether the automatic transport unit is in a second state type where a not automatically fixable fault occurs but the movement of the automatic transport unit is not affected; and the control unit is further configured to, in response to determining that the automatic transport unit is in the second state type, control the automatic transport unit to move to a specific position.

In the above automatic logistics sorting system, the second state type includes one of: that the automatic transport unit detects that an execution duration of dropping the item to be sorted exceeds a predetermined time threshold; that the automatic transport unit detects that the number of transported items to be sorted is different from a previously set number; or that the automatic transport unit detects that it is unable to receive an external instruction.

In the above automatic logistics sorting system, the determining unit is further configured to determine whether the automatic transport unit is in a third state type where the automatic transport unit deviates from a normal travel route; and the control unit is further configured to, in response to determining that the automatic transport unit is in the third state type, control the automatic transport unit to correct the travel route of the automatic transport unit.

In the above automatic logistics sorting system, the determining unit is further configured to determine whether the automatic transport unit is in a fourth state type where the automatic transport unit needs to be charged; and the control unit is further configured to, in response to determining that the automatic transport unit is in the fourth state type, control the automatic transport unit to travel to a preset charging position.

In the above automatic logistics sorting system, the determining unit is further configured to determine whether the automatic transport unit is in a fifth state type where a fault occurs and the automatic transport unit is unable to move; and the control unit is further configured to, in response to determining that the automatic transport unit is in the fifth state type, determine a position of the automatic transport unit and determine a disabled area according to the position.

In the above automatic logistics sorting system, the control system further includes stop all automatic transport units in the disabled area from moving, and control a travel route of an automatic transport unit moving outside the disabled area to make the automatic transport unit avoid the disabled area.

In the above automatic logistics sorting system, the determining unit is further configured to determine whether the automatic transport unit is in a sixth state type where the item to be sorted is abnormal; and the control unit is further configured to, in response to determining that the automatic transport unit is in the sixth state type, control the automatic transport unit to stop moving and send its current position information to the control system for further processing.

In the above automatic logistics sorting system, the control system is further configured to re-plan travel routes of other automatic transport units based on the current position information.

In the above automatic logistics sorting system, the sorting area further includes: an item supplying area, which is configured to distribute the item to be sorted; a transport area, which is configured to allow one or more automatic transport units to move therein, where the one or more automatic transport units are configured to transport the item to be sorted to pass through the transport area; and an item dropping area, which includes a plurality of sorting target objects, where the automatic transport unit drops the item to be sorted into a corresponding sorting target object in the item dropping area. The transport area and the item dropping area are located on the same plane and do not overlap.

According to another aspect of the present application, an automatic logistics sorting method is provided. The automatic logistics sorting method includes: placing one or more items to be sorted on an automatic transport unit in an item supplying area; obtaining item related information of the one or more items to be sorted; determining a specific sorting target object corresponding to the one or more items to be sorted based on the item related information; carrying, by the automatic transport unit, the one or more items to be sorted to pass through a transport area; and moving, by the automatic transport unit, to an item dropping area, and dropping the one or more items to be sorted to a corresponding specific sorting target object. The automatic logistics sorting method further includes: detecting a state of the automatic transport unit; determining a state type of the automatic transport unit; and in response to determining that the automatic transport unit is in a first state type where an automatically fixable fault occurs, controlling the automatic transport unit to automatically fix the fault.

In the above automatic logistics sorting method, determining the state type of the automatic transport unit further includes: in response to determining that the automatic transport unit is not in the first state type where an automatically fixable fault occurs, determining whether the automatic transport unit is in a second state type where a not automatically fixable fault occurs but movement of the automatic transport unit is not affected; and the automatic logistics sorting method further includes: in response to determining that the automatic transport unit is in the second state type, controlling the automatic transport unit to move to a specific position.

In the above automatic logistics sorting method, the second state type includes one of: that the automatic transport unit detects that an execution duration of dropping the one or more items to be sorted exceeds a predetermined time threshold; that the automatic transport unit detects that the number of the transported one or more items to be sorted is different from a previously set number; or that the automatic transport unit detects that it is unable to receive an external instruction.

In the above automatic logistics sorting method, determining the state type of the automatic transport unit further includes: determining whether the automatic transport unit is in a third state type where from the automatic transport unit deviates from a normal travel route; and the automatic logistics sorting method further includes: in response to determining that the automatic transport unit is in the third state type, controlling the automatic transport unit to correct the travel route of the automatic transport unit.

In the above automatic logistics sorting method, determining the state type of the automatic transport unit further includes: determining whether the automatic transport unit is in a fourth state type where the automatic transport unit needs to be charged; and the automatic logistics sorting method further includes: in response to determining that the automatic transport unit is in the fourth state type, controlling the automatic transport unit to travel to a preset charging position.

In the above automatic logistics sorting method, determining the state type of the automatic transport unit further includes: determining whether the automatic transport unit is in a fifth state type where a fault occurs and the automatic transport unit is unable to move; and the automatic logistics sorting method further includes: in response to determining that the automatic transport unit is in the fifth state type, determining a position of the automatic transport unit and determining a disabled area according to the position.

In the above automatic logistics sorting method, determining the position of the automatic transport unit specifically includes: stopping all automatic transport units in the disabled area from moving, and controlling a travel route of an automatic transport unit moving outside the disabled area to make the automatic transport unit avoid the disabled area.

In the above automatic logistics sorting method, determining the state type of the automatic transport unit further includes: determining whether the automatic transport unit is in a sixth state type where the one or more items to be sorted are abnormal; and the automatic logistics sorting method further includes: in response to determining that the automatic transport unit is in the sixth state type, controlling the automatic transport unit to stop moving and sending its current position information to a control system for further processing.

In the above automatic logistics sorting method, the automatic logistics sorting method further includes: re-planning travel routes of other automatic transport units based on the current position information.

In the above automatic logistics sorting method, the transport area and the item dropping area are located on the same plane and do not overlap.

The automatic logistics sorting method and automatic logistics sorting system provided by the present application may implement the high-efficiency item sorting by adopting the mechanism for automatically processing the abnormal item.

### BRIEF DESCRIPTION OF DRAWINGS

FIG. 1 is a schematic diagram of an example existing automatic logistics sorting system using robots;

FIG. 2 is a schematic diagram of an exemplary area arrangement of an automatic logistics sorting system according to an embodiment of the present application;

FIG. 3 is a block diagram of an automatic logistics sorting system according to an embodiment of the present application;

FIG. 4 is a block diagram of an abnormal item processing device according to an embodiment of the present application;

FIG. 5 is a flowchart of an automatic logistics sorting method according to an embodiment of the present application;

FIG. 6 is a block diagram of a fault processing device according to an embodiment of the present application; and

FIG. 7 is a flowchart of another automatic logistics sorting method according to an embodiment of the present application.

### DETAILED DESCRIPTION

The following description is intended for disclosing the present application so as to enable those skilled in the art to implement the present application. The preferred embodiments in the following description are used only as examples, and those skilled in the art may conceive of other apparent variations. The basic principles of the present application as defined in the following description may be applied to other embodiments, modifications, improvements, equivalents, and other technical solutions without departing from the spirit and scope of the present application.

The present application will be described in further detail with reference to the drawings and specific embodiments.

Example Layout of an Automatic Logistics Sorting System

In an existing automatic logistics sorting system adopting a robot, first the system adopts an elevated platform structure (for example, a steel platform), the robot runs above the platform, and the container for receiving the packages is located below the platform. Such a structure can serve sorting purposes, but the building and use of the platform reduces the flexibility and increases the costs. Therefore, there is a need for an automatic logistics sorting system with greater flexibility and lower cost.

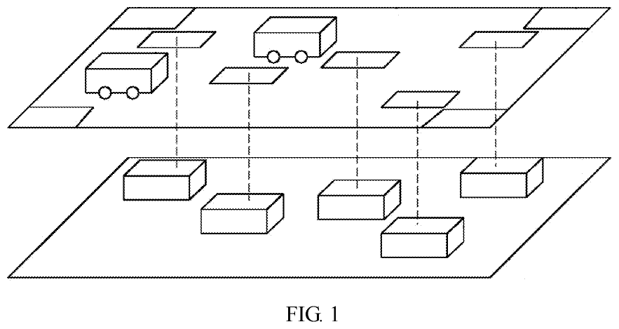

In addition, in the above system, goods dropping openings are arranged in the form of an array in the area where the robot moves (as illustrated in FIG. 1, the goods dropping openings are arranged in the form of an array in a plane of the steel platform). Therefore, when one robot is performing an item dropping task, other robots may have to wait, or they may come cross each other so that they have to avoid each other. Waiting or avoiding of the robots will reduce the sorting efficiency of the entire system. In particular, when there is a large number and a large density of robots in the system, the waiting or avoiding of the robots during the performance of the item dropping tasks may rapidly reduce the efficiency of the entire system.

Therefore, it is expected to further improve the automatic logistics sorting system to overcome the bottleneck of system efficiency, reduce the waiting or avoiding of the robots caused by the item dropping of the robot, and effectively improve the efficiency of the automatic logistics sorting system.

Regarding the flexibility of the automatic logistics sorting system, the automatic logistics sorting system has high flexibility requirements because of the periodical feature of the logistics industry. Specifically, in the logistics industry, the items that need to be transported exhibit a distinct peak-to-valley distribution. For example, for the express delivery industry, the volume of goods will sharply increase during large-scale online shopping festivals, and the amount of goods will significantly reduce during holidays such as the Spring Festival. Therefore, the automatic logistics sorting system is required to be capable of coping well with the imbalance of the quantity of goods that need to be transported, so as to ensure that the system meet the demands while not causing the system to stand idle.

Therefore, according to an exemplary embodiment of the present application, there is provided an automatic logistics sorting system. The automatic logistics sorting system includes: an item supplying area, which is configured to distribute the item to be sorted; a transport area, which is configured to allow one or more automatic transport units to move therein, where the automatic transport unit is configured to transport the item to be sorted; and an item dropping area, which includes multiple sorting target objects, where the automatic transport unit is configured to drop the item to be sorted to a corresponding sorting target object in the item dropping area. The transport area and the item dropping area are located on the same plane and do not overlap.

Compared with the automatic logistics sorting system having the form of “robot plus steel platform” shown in FIG. 1, the automatic logistics sorting system in the embodiment of the present application adopts a planar arrangement. That is, the transport area and the item dropping area are set in the same plane, thereby avoiding the costs caused by elevating the transport area.

Typically, in the automatic logistics sorting system in the embodiment of the present application, the transport area and the item dropping area are disposed on the ground.

In this way, the automatic logistics sorting system in the embodiment of the present application further adopts a “floor standing” structure, so that the transport area and the item dropping area are located in the same plane. Correspondingly, the automatic transport unit moving in the transport area and sorting target objects included in the item dropping area are also located in the same plane, thereby eliminating the need to build a separate platform for the automatic transport unit, and avoiding loss in flexibility and cost.

Of course, it will be understood by those skilled in the art that in the automatic logistics sorting system in the embodiment of the present application the transport area and the item dropping area may be directly disposed on the ground, or may be disposed in other planes as needed. For example, the automatic logistics sorting system in the embodiment of the present application may also be implemented as a three dimensional automatic logistics sorting system including multilayered planes on which the transport area and the item dropping area are arranged. This is particularly suitable for situations with limited site conditions, thereby fully utilizing the height space and reducing the cost of the automatic logistics sorting system.

In addition, in the automatic logistics sorting system in the embodiment of the present application, the transport area and the item dropping area do not overlap. That is, the transport area and the item dropping area occupy different parts of the planar physical space, so that the automatic transport unit during the performance of item dropping does not need to wait for the item dropping of other automatic transport units or avoid the other automatic transport units, thereby significantly improving the efficiency of the automatic logistics sorting system.

The automatic transport unit in the automatic logistics sorting system in the embodiment of the present application may be a robot, or may be another automatic transport unit for transporting items.

In addition, the sorting target objects in the automatic logistics sorting system in the embodiment of the present application relate to corresponding categories after the item to be sorted is sorted. For example, in the express delivery industry, one sorting target object typically corresponds to a special transport route, and the sorting target object may be a container for containing packages transported in the transport route. However, it will be understood for those skilled in the art that the sorting target object in the embodiment of the present application is not limited to a specific transport route, and may also be other categories corresponding to sorted items, such as the item size, the item characteristics (such as fragility), and the like.

In summary, the automatic logistics sorting system in the embodiment of the present application provides an automatic logistics sorting system having a planar non-overlapping area arrangement, the core of which is the planar non-overlapping arrangement of the transport area and the item dropping area. Therefore, it will be understood by those skilled in the art that whether the item to be sorted is actually sorted in the automatic logistics sorting system in the embodiment of the present application is not an essential feature of the automatic logistics sorting system in the embodiment of the present application. That is, even if there is no automatic transport unit to transport the item to be sorted from the item supplying area to the item dropping area through the transport area, the planar non-overlapping arrangement of the transport area and the item dropping area shall all fall in the scope of the present application.

In addition, the multiple sorting target objects included in the item dropping area are also not necessarily entity objects. For example, the item dropping area may be divided into multiple areas, where each area corresponds to one sorting target object, thereby accomplishing the item sorting. Of course, the sorting target object may also be an entity shelf, a basket, or the like. In order to improve the system flexibility, when the sorting target object is the container for containing the item, the container may typically be moveable, so that the container may be easily replaced after being filled.

That is, in the automatic logistics sorting system in the embodiment of the present application, the sorting target object may be a movable container configured for containing sorted items.

As mentioned above, in the automatic logistics sorting system in the embodiment of the present application, the transport area and the item dropping area are disposed on the same plane and do not overlap. Furthermore, the item supplying area in the automatic logistics sorting system is located in the same plane as the transport area and the item dropping area does not overlap with the transport area and the item dropping area. In this way, high flexibility, low cost and high efficiency of the automatic logistics sorting system in the embodiment of the present application may be further ensured by the arrangement of the item supplying area.

In the actual layout of the item supplying area, the transport area and the item dropping area, the automatic logistics sorting system in the embodiment of the present application may adopt various solutions. In summary, the item supplying area and the item dropping area toned to be arranged according to the transport area. For example, in an example, the item supplying area and the item dropping area are respectively disposed on two sides of the transport area, so that the automatic transport unit implements the item sorting by transporting the items from the item supplying area to different sorting target objects in the item dropping area. The transport area may be of various shapes according to actual site conditions. For example, the transport area may be a common rectangle or a square. In this case, the item supplying area may be disposed in the center of one side of the transport area and the item dropping area is disposed on the opposite side of the transport area. It will be understood by those skilled in the art that, when more sorting target objects are involved and the area of the transport area is limited, the item dropping area may be disposed on multiple sides of the transport area. For example, the item dropping area may be disposed on three other sides of the rectangular or square transport area other than the side on which the item supplying is located, thereby meeting the requirements of the item sorting.

In another example, the item supplying area may be disposed in the center of the transport area, and the item dropping area may be disposed around the transport area, so that the site of the transport area may be used to its fullest extent, which is especially suitable for cases where site conditions are limited.

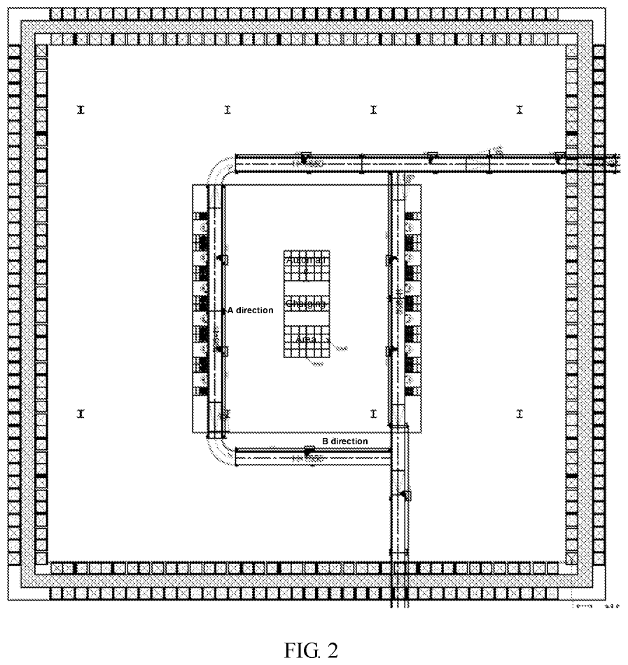

FIG. 2 is a schematic diagram of an example area arrangement of an automatic logistics sorting system according to an embodiment of the present application. As illustrated in FIG. 2, the item supplying area is disposed in the center of a site, the item dropping area is disposed around the site, and an area between the item supplying area and the item dropping area is the transport area. In FIG. 2, since the item to be sorted needs to be transported to the item supplying area for sorting, a space for transporting the item to be sorted to the item supplying area is left on one side of the site. It will be understood by those skilled in the art that, if the item to be sorted has been transported to the item supplying area in advance, the right side in FIG. 2 may be arrangement as the item dropping area.

That is, even if the item supplying area is arranged in the center of the transport area, the item dropping area is not necessarily arranged around the transport area. Instead, an appropriate number of sorting target objects may be set according to the specific sorting requirements, so that whether all sorting target objects may be accommodated on one side of the transport area or whether they need to occupy one or more other sides can be determined.

In addition, from another perspective, in the automatic logistics sorting system in the embodiment of the present application, since the item to be sorted is transported from the item supplying area to the item dropping area, the transport area is apparently located between the item supplying area and the item dropping area. Therefore, it may be considered that the shapes of the item supplying area and the item dropping area, especially the shape of the item dropping area, determine the shape of the transport area. Therefore, the layout of the item dropping area may be first determined, and the layout of the transport area may be determined according to the shape of the item dropping area.

Since the sorting target object is preferably movable as mentioned above, the automatic logistics sorting system in the embodiment of the present application may set an appropriate number of sorting target objects according to the number of items to be sorted. Similarly, using the package in the express delivery industry as an example, assuming that the package needs to be sorted to correspond to 30 routes. The number of packages in each route may be determined according to existing data, so that multiple sorting target objects would be set to correspond to the same route. For example, if the number of packages corresponding to a certain route is determined as large, multiple sorting target objects corresponding to the route may be set, so that packages corresponding to this route may be sorted in parallel without reducing the overall efficiency of the system because of this route. In addition, if the number of packages to be sorted increases significantly during a certain period of time, the number of sorting target objects corresponding to each route may be increased in general. For example, if each route corresponds to one sorting target object in normal periods, the number of sorting target objects corresponding to each route may be set to two or more at the busy hours, thereby enabling the automatic logistics sorting system in the embodiment of the present application to respond well to the periodical feature of the logistics industry with good flexibility.

Of course, in cases where the number of sorting target objects is increased, the area of the original item dropping area may be insufficient to accommodate the sorting target objects. The area of the item dropping area may be accordingly enlarged by enlarging only the area of the transport area.

In addition, since the item supplying area, the transport area and the item dropping area are arranged in the same plane in the automatic logistics sorting system in the embodiment of the present application, the automatic logistics sorting system may also be simply replicated on the ground, apart from the implementation of the automatic logistics sorting system in the three dimensional manner as described above.

Specifically, the capacity of the automatic logistics sorting system in the embodiment of the present application may be expanded in the manner described above in which the area of the item dropping area is enlarged by enlarging the area of the transport area. However, in cases where the area of the transport area is enlarged, the travel route of the automatic transport unit in the transport area is also changed. For the automatic transport unit such as a robot, apparently travelling according to a preset path is an optimal solution. Therefore, in order to avoid the influence of the change of the transport area on the travel of the automatic transport unit, the automatic logistics sorting system in the embodiment of the present application may be replicated as a whole without changing the transport area. That is, another new automatic logistics sorting system is set, but it maintains the same planar layout of the item supplying area, the transport area and the item dropping area as that in the old automatic logistics sorting system, so that the setting of the automatic transport unit stays the same.

That is, according to another exemplary embodiment of the present application, there is provided an automatic logistics sorting system that includes: a first item supplying area, which is configured to distribute the item to be sorted; a first transport area, which is configured to allow one or more automatic transport units to move therein, where the one or more automatic transport units are configured to transport the item to be sorted; and a first item dropping area, which includes multiple sorting target objects, where the one or more automatic transport units are configured to drop the item to be sorted into a corresponding sorting target object in the first item dropping area. The first transport area and the first item dropping area are located on the same plane and do not overlap. The automatic logistics sorting system further includes a second item supplying area, a second transport area and a second item dropping area. A second planar layout of the second item supplying area, the second transport area and the second item dropping area is the same as a first planar layout of the first item supplying area, the first transport area and the first item dropping area.

It will be understood by those skilled in the art that the same planar layout refers to that the planar layout of each area is the same, but is not intended to limit the number of automatic transport units moving in the second transport area and the number of sorting target objects included in the second item dropping area to be respectively the same as those in the first transport area and the first item dropping area.

In addition, according to an exemplary embodiment of the present application, there is provided an automatic logistics sorting system that includes: an automatic transport unit, which is configured to transport the item to be sorted; a sorting area, which is configured to allow the automatic transport unit to operate therein to implement the sorting of the item to be sorted; and a control device, which is configured to control the sorting of the item to be sorted and movement of the automatic transport unit in the sorting area. The sorting area further includes: an item supplying area, which is configured to distribute the item to be sorted; a transport area, which is configured to allow one or more automatic transport units to move therein, where the automatic transport unit is configured to transport the item to be sorted to pass through the transport area; and an item dropping area, which includes multiple sorting target objects, where the automatic transport unit is configured to drop the item to be sorted into a corresponding sorting target object in the item dropping area. The transport area and the item dropping area are located on the same plane and do not overlap.

FIG. 3 is a block diagram of an automatic logistics sorting system according to an embodiment of the present application. As illustrated in FIG. 3, the automatic logistics sorting system 200 in the embodiment of the present application includes: an automatic transport unit 210, which is configured to transport the item to be sorted; a sorting area 202, which is configured to allow the automatic transport unit 210 to operate therein to implement the sorting of the item to be sorted; and a control device 220, which is configured to control the sorting of the item to be sorted and the movement of the automatic transport unit 210 in the sorting area. The sorting area 202 further includes: an item supplying area 221, which is configured to distribute the item to be sorted; a transport area 222, which is configured to allow one or more automatic transport units 210 to move therein, where the one or more automatic transport units 210 are configured to transport the item to be sorted to pass through the transport area 222; and an item dropping area 223, which includes multiple sorting target objects, where the one or more automatic transport units 210 are configured to drop the item to be sorted into a corresponding sorting target object in the item dropping area. The transport area 222 and the item dropping area 223 are located on the same plane and do not overlap.

In the above automatic logistics sorting system, the transport area and the item dropping area are directly arranged on the ground.

In the above automatic logistics sorting system, the item supplying area, the transport area and the item dropping area are located on the same plane and do not overlap with each other.

In the above automatic logistics sorting system, the item supplying area is located on one side of the transport area, and the item dropping area is located on one or more sides of the transport area other than the side where the item supplying area is located.

In the above automatic logistics sorting system, the item supplying area is located in the center of the transport area, and the item dropping area is located on at least part of the periphery of the transport area.

In the above automatic logistics sorting system, the sorting target object is a moveable container configured for containing sorted items.

Automatic Logistics Sorting System Having an Abnormality Processing Mechanism

In the above automatic logistics sorting system, the sorting of the item to be sorted may go abnormal and therefore, an abnormality processing mechanism for the item to be sorted may further be included.

That is, according to one aspect of the present application, in the above automatic logistics sorting system, the control device, such as the control device 220 illustrated in FIG. 3, further includes a function for processing the abnormal item. That is, the control device 220 further includes: a setting unit, which is configured to set a specific sorting target object for abnormality processing; a determining unit, which is configured to determine whether the item to be sorted is abnormal; and a control unit, which is configured to, in response to determining that the item to be sorted is abnormal, control to transport the item to be sorted to the specific sorting target object for the abnormality processing.

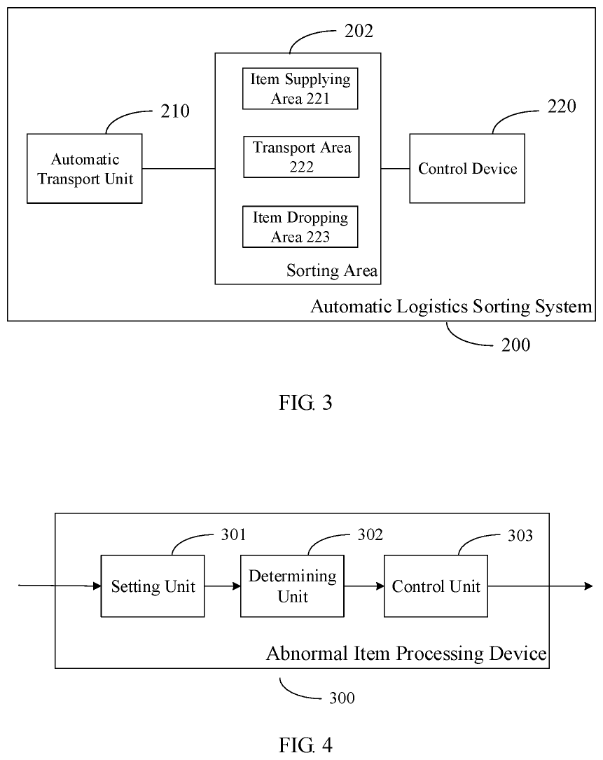

For example, the above function for processing the abnormal item may be implemented by an abnormal item processing device. FIG. 4 is a block diagram of an abnormal item processing device according to an embodiment of the present application. As illustrated in FIG. 4, the abnormal item processing device 300 in the embodiment of the present application includes: a setting unit 301, which is configured to set a specific sorting target object for abnormality processing; a determining unit 302, which is configured to determine whether the item to be sorted is abnormal; and a control unit 303, which is configured to, in response to determining by the determining unit 302 that the item to be sorted is abnormal, control to transport the item to be sorted to the specific sorting target object for the abnormality processing set by the setting unit 301.

Therefore, in the abnormal item processing device in the embodiment of the present application, when the item to be sorted is detected as abnormal, the item sorting process may not necessarily wait for the processing of the abnormal item, but abnormal items may be collectively transported to a specific destination in the item dropping area, that is, the above-mentioned specific target sorting object may be uniformly processed, thereby significantly improving the sorting efficiency.

It will be understood by those skilled in the art that the automatic logistics sorting system in the embodiment of the present application is configured to control the item sorting in the logistics process, and the item to be sorted may be, for example, the package of the express delivery industry, or may be other items which need to be transported after being sorted.

The abnormal item processing device in the embodiment of the present application may be applied to automatic logistics sorting systems having various layouts, for example, the automatic logistics sorting system having the planar non-overlapping layout described above.

Therefore, an embodiment of the present application provides an automatic logistics sorting system, which includes: an automatic transport unit, which is configured to transport an item to be sorted; a sorting area, which is configured to allow the automatic transport unit to operate therein to implement sorting of the item to be sorted, where the sorting area includes an item dropping area including multiple sorting target objects, and the automatic transport unit is configured to drop the item to be sorted into a corresponding sorting target object in the item dropping area; and a control system, which is configured to control the sorting of the item to be sorted and movement of the automatic transport unit in the sorting area, the control system including: a setting unit, which is configured to set a specific sorting target object among the multiple sorting target objects for abnormality processing; a determining unit, which is configured to determine whether the item to be sorted is abnormal; and a control unit, which is configured to, in response to determining that the item to be sorted is abnormal, control to transport the item to be sorted to the specific sorting target object for the abnormality processing.

In the above automatic logistics sorting system, the sorting area further includes: an item supplying area, which is configured to distribute the item to be sorted, and a transport area, which is configured to allow one or more automatic transport units to move therein, where the one or more automatic transport units are configured to transport the item to be sorted to pass through the transport area. The transport area and the item dropping area are located on the same plane and do not overlap.

In the above automatic logistics sorting system in the embodiment of the present application, the abnormal item may be processed at an item supplying end or an item dropping end. For example, if no other automatic transport unit waits at the item supplying end and the abnormality of the item is easy to handle, such as that the express sheet of the package is pleated and is not recognizable, then the abnormal item may be processed at the item supplying end.

However, if the abnormality of the item is difficult to deal with, for example, in some cases described below where the abnormal item needs to be transported to the same specific sorting target object configured for the abnormality processing for further processing, which will be specifically described below.

The abnormality processing at the item supplying end and the abnormality processing at the item dropping end may be combined to implement the processing of the abnormal item.

Therefore, in the above automatic logistics sorting system, the control system further includes at least one selected from the group consisting of the following: a first processing unit, which is configured to process an abnormal item in the item supplying area; or a second processing unit, which is configured to process the abnormal item in the specific sorting target object configured for the abnormality processing.

Serval abnormal cases of the item to be sorted will be further described below.

In the above abnormality processing device, the determining unit is specifically configured to determine whether the item to be sorted does not have corresponding sorting destination information, and the second processing unit is specifically configured to re-determine a sorting destination of the item to re-sort the item.

That is, in the automatic logistics sorting system in the embodiment of the present application, the corresponding sorting destination information of the item to be sorted may not be able to be determined. That is, the automatic logistics sorting system detects the item to be sorted and may not be able to determine to which sorting destination the item to be sorted is transported. Therefore, in this case, the item to be sorted may apparently not be able to be transported. For example, when the robot carrying the package passes a package inspection device, when if to which item dropping opening the package is transported cannot be determine, then the robot will not be able to be further navigated by the control system to a certain item dropping opening, so that the robot would have to wait in the sorting process. In addition to the robot that is transporting the abnormal package, other robots that pass through the package inspection device may also be affected, further reducing the system efficiency.

Specifically, there may be several specific cases where the corresponding sorting destination the item to be sorted may not be able to be determined.

In a first case, no destination is configured. For example, a logical destination of the package is detected, but no corresponding delivery port is configured for the logical destination. In package sorting, the system may not find a delivery port corresponding to the package in the configured correspondence table concerning delivery sites and the provinces/municipalities/autonomous regions.

In another case, there may be no destination information. For example, no destination information is found in the waybill information of the package, or the delivery site information in the waybill is not maintained, so that the destination information may not be able to be obtained from the movement information of the package.

In yet another case, the destination information fails to be identified. For example, the bar code fails to be read after the item passes through the package inspection entrance.

Therefore, in the above automatic logistics sorting system, the determining unit is specifically configured to determine that the corresponding item information of the item to be sorted does not have a sorting destination corresponding to the item information.

In the above automatic logistics sorting system, the determining unit is specifically configured to determine whether the item to be sorted has not recorded the item information relating to the corresponding sorting destination.

In the above automatic logistics sorting system, the determining unit is specifically configured to determine whether the item information recorded on the item to be sorted is unidentifiable.

In the above cases, the sorting destination of the item to be sorted needs to be re-determined, and the item to be sorted needs to be re-distributed, so that the logistics sorting system may determine the corresponding sorting destination of the item to be sorted, and the item to be sorted may be re-sorted.

In still another case, the item to be sorted may have superfluous destination information.

That is, in the above automatic logistics sorting system, the determining unit is specifically configured to determine whether the item to be sorted has multiple pieces of corresponding sorting destination information; and the second processing unit is specifically configured to record abnormality information of the item, and identify one of the multiple pieces of sorting destination information of the item to re-sort the item.

That is, when the item to be sorted has superfluous destination information, one of the multiple pieces of sorting destination information of the item to re-sort the item may be defaulted as the destination of the item to be sorted to re-sort the item to be sorted. For example, the first destination of the multiple pieces of destination information may be used as the destination of the item to be sorted, or the destination information with a destination which is the most likely to be the destination of the item to be sorted may be identified from the multiple pieces of destination information by other methods.

In addition, in the process of selecting a sorting destination, illegal destination information may have been removed in accordance with a specific policy. For example, when the sorting destination of the item to be sorted is recorded by the bar code, illegal bar codes may be removed in advance. When multiple pieces of destination information still exist after illegal destination information is removed, the abnormal item may be re-sorted according to steps described above.

In the automatic logistics sorting system in the embodiment of the present application, the sorting destination refers to a target object after the item to be sorted is sorted, that is the sorting target object described above. For example, in the e-commerce package sorting, each sorting destination corresponds to a specific efficiency of a transport package, such as Beijing, Shanghai, etc. At this moment, the sorting destination may be a specific area specially used for the sorted packages, or may be an item dropping opening illustrated in FIG. 1, or may be a specific container used to contain the sorted items, such as shelves, baskets, etc. Typically, the specific container for containing the sorted items may be moveable, so that the container may be moved as a whole after being filled with the sorted items to be transported.

Therefore, in the above automatic logistics sorting system, the sorting target object corresponds to the moveable container configured for containing the sorted items.

In addition, although the abnormality processing device in the embodiments of the present application is described as a part of the control device of the automatic logistics sorting system, it may also be a separate control device. When combined with the control system in the automatic logistics sorting system, the abnormality processing device may be a functional module of the control system.

Through the automatic logistics sorting system having a mechanism for automatically processing an abnormal item in the embodiment of the present application, the abnormal items to be sorted may not be processed in the item sorting process, and multiple abnormal items may be collectively processed after the item sorting process is completed. Therefore, the influence of the processing of the abnormal item on the item sorting process is avoided, thereby improving the item sorting efficiency.

For example, when the robot transports the package, if a package is found abnormal, the robot still transports the package to the specific destination. The way of processing the abnormal package is the same as the way of processing the normal package. Therefore, the navigation setting of the robot may not be completely altered, and other related parts in the control system may not need to be altered, which save the system reconstruction cost.

In addition, since the robot transports the abnormal package in the same way as the normal package, the overall operation of all robots is not affected, and avoidance and waiting due to the abnormality processing do not occur among robots, thereby significantly improving the overall operational efficiency of the system.

It will be understood by those skilled in the art that the abnormal item processing device in the embodiment of the present application may be applied to various automatic logistics sorting systems, such as the automatic logistics sorting system in the form of “robot plus steel platform” shown in FIG. 1.

An example of the automatic logistics sorting system of the embodiment of the present application will be described below. In the automatic logistics sorting system of this example, the item supplying area is in a form of an item supplying stand, and the package to be sorted is manually or automatically placed on a mobile transport device. In addition, the automatic logistics sorting system in this example may include a package inspection entrance provided with a package inspection device. The package inspection device includes a package information acquiring device for acquiring package information of the package to be sorted entering the package inspection entrance corresponding to the package information acquiring device. The package information includes a destination of the package to be sorted, that is, the sorting target object described above. Typically, the package inspection entrance is disposed in the item supplying area.

The mobile transport device may be, for example, a robot. When moving in the transport section, the mobile transport device is configured to carry one or more packages to be sorted. The destination information of the package to be sorted is included in a destination information code. The destination information code is disposed on the package to be sorted, so that the mobile transport device may carry the package to a sorting destination.

In addition, the transport section may include a transport travelling platform. The transport travelling platform refers to a platform where the mobile transport device travels, and may be ground, a certain constructed platform, a track or the like.

An item dropping end is disposed at the peripheral edge of the transport section as the item dropping area. The item dropping end is provided with a package storage device. The mobile transport device travels to the item dropping end, and drops the package to be sorted into the package storage device at the item dropping end.

In addition, the automatic logistics sorting system in this example includes a control system interconnected to the package inspection device and the mobile transport device. The control system provides task or scheduling information for the mobile transport device based on the package related information, and controls the mobile transport device to complete the complete package sorting processes and tasks.

The control device may further include an abnormal item processing device. The abnormal item processing device includes: a setting unit, which is configured to set a specific sorting target object in the multiple sorting target objects for abnormality processing; a determining unit, which is configured to determine whether the item to be sorted is abnormal; and a control unit, which is configured to, in response to determining that the item to be sorted is abnormal, control to transport the item to be sorted to the specific sorting target object for the abnormality processing.

In addition, as mentioned above, the automated logistics sorting system may itself include a control system to control the sorting of items to be sorted to respective sorting destinations.

That is, according to an exemplary embodiment of the present application, there is provided an automatic logistics sorting system, which includes: an item supplying stand, which is configured to place an item to be sorted on an automatic transport unit; an item inspection device, which is configured to acquire item related information of the item to be sorted; a control device, which is configured to determine one or more sorting destinations corresponding to the item to be sorted based on the item related information; a transport area, which is configured to allow the control device to control the automatic transport unit to pass through the transport area to arrive at the sorting destination; and an item dropping area, which includes the sorting destination and is configured to allow the automatic transport unit to drop the item to be sorted to the sorting destination. The transport area and the item dropping area are located on the same plane and do not overlap. The control device further includes: a setting unit, which is configured to set a specific sorting target object for abnormality processing; a determining unit, which is configured to determine whether the item to be sorted is abnormal based on the information related to the item to be sorted acquired by the item inspection device; and a control unit, which is configured to, in response to determining that the item to be sorted is abnormal, control to transport the item to be sorted to the specific sorting target object for the abnormality processing.

Of course, it will be understood by those skilled in the art that the item inspection device and the control device including an automatic logistics sorting control mechanism may be integrated into an overall control system to control the item sorting in general. Since the abnormality information of the item to be sorted is included in the item related information of the item to be sorted acquired by the item inspection device, the control unit for controlling the transportation of the abnormal item may be used as a part of a control device for controlling the transportation of all the items in general.

That is, according to another exemplary embodiment of the present application, there is provided an automatic logistics sorting system which includes: an automatic transport unit, which is configured to transport an item to be sorted; a sorting area, which is configured to allow the automatic transport unit to operate therein to implement the sorting of the item to be sorted; and a control device, which is configured to control the sorting of the item to be sorted and movement of the automatic transport unit in the sorting area. The sorting area further includes: an item supplying area, which is configured to distribute the item to be sorted; a transport area, which is configured to allow one or more automatic transport units to move therein, where the one or more automatic transport units are configured to transport the item to be sorted to pass through the transport area; and an item dropping area, which includes multiple sorting target objects, where the one or more automatic transport units are configured to drop the item to be sorted to a corresponding sorting target object in the item dropping area. The transport area and the item dropping area are located on the same plane and do not overlap. The control system further includes an abnormal item processing device. The abnormal item processing device includes: a setting unit, which is configured to set a specific sorting target object in the multiple sorting target objects for abnormality processing; a determining unit, which is configured to determine whether the item to be sorted is abnormal; and a control unit, which is configured to, in response to determining that the item to be sorted is abnormal, control to transport the item to be sorted to the specific sorting target object configured for the abnormality processing.

In the automatic logistics sorting system in the embodiment of the present application, an abnormal item control device may determine the number of specific sorting target objects for the abnormality processing according to quantitative proportions of items to be sorted corresponding to different sorting target objects. For example, the larger the number of items to be sorted is, the larger the number of abnormal items is. Therefore, more specific sorting target objects for the abnormality processing may typically be set. In addition, positions of the abnormal sorting objects for the abnormality processing in the item dropping area need to be determined according to the quantitative proportions of the items to be sorted corresponding to different sorting target objects. Specifically, considering the route optimization of the automatic transport unit in transport section, specific sorting objects for the abnormality processing are typically disposed at the edge of the item dropping area. For example, in the case described above where the item supplying stand is deposed in the middle and the item dropping area is disposed in the periphery, the specific sorting objects for the abnormality processing are preferably disposed in four corners of the item dropping area.

Therefore, in the above automatic logistics sorting system, the setting unit in the abnormal item control device may determine the number of specific sorting target objects for the abnormality processing and/or positions of the specific sorting target objects configured for the abnormality processing in the item dropping area based on quantitative proportions of items to be sorted corresponding to different sorting target objects.

Automatic Logistics Sorting Method Having an Abnormality Processing Mechanism

According to another aspect of the present application, there is provided an automatic logistics sorting method which includes: placing one or more items to be sorted on an automatic transport unit in an item supplying area; obtaining item related information of the one or more items to be sorted, where the item related information includes abnormality information of the one or more items to be sorted; setting an abnormality sorting target object for abnormality processing; determining a specific sorting target object corresponding to the one or more items to be sorted based on the item related information, where the item to be sorted having the abnormality information corresponds to the abnormality sorting target object for the abnormality processing; carrying, by the automatic transport unit, the one or more items to be sorted to pass through a transport area, where the item to be sorted having the abnormality information is transported to the abnormality sorting target object configured for the abnormality processing; and moving, by the automatic transport unit, to an item dropping area, and dropping the one or more items to be sorted to a corresponding specific sorting target object.

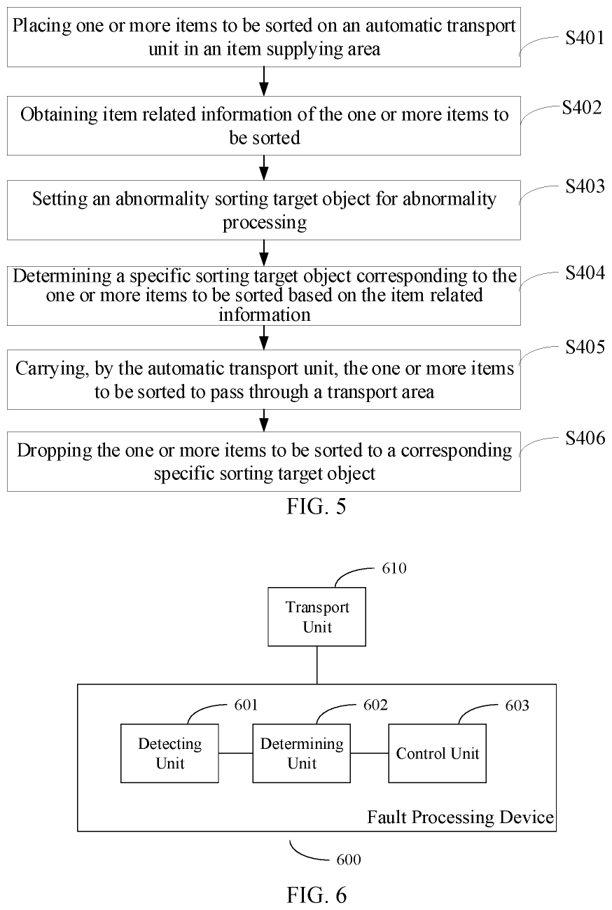

FIG. 5 is a flowchart of an automatic logistics sorting method according to an embodiment of the present application. As illustrated in FIG. 5, the automatic logistics sorting method in the embodiment of the present application includes steps described below. In step S401, one or more items to be sorted are placed on an automatic transport unit in an item supplying area. In step S402, item related information of the one or more items to be sorted is obtained, where the item related information includes abnormality information of the one or more items to be sorted. In step S403, an abnormality sorting target object for abnormality processing is set. In step S404, specific sorting target objects corresponding to the one or more items to be sorted are determined based on the item related information, where the item to be sorted having the abnormality information corresponds to the abnormality sorting target object for the abnormality processing. In step S405, the automatic transport unit carries the one or more items to be sorted to pass through a transport area, where the item to be sorted having the abnormality information is transported to the abnormality sorting target object for the abnormality processing. In step S406, the automatic transport unit travels to an item dropping area, and drops the one or more items to be sorted to a corresponding specific sorting target object.

In the above automatic logistics sorting method, the transport area and the item dropping area are located on the same plane and do not overlap.

In the above automatic logistics sorting method, the method further includes performing a first processing on an abnormal item in the item supplying area; and/or performing a second processing on the abnormal item in the specific sorting target object for the abnormality processing.

In the above automatic logistics sorting method, the abnormality information of the one or more items to be sorted includes that the one or more items to be sorted do not have corresponding sorting destination information, and the step of further processing the abnormal includes re-determining a sorting destination of the item to re-sort the item.

In the above automatic logistics sorting method, that the one or more items to be sorted do not have the corresponding sorting destination information includes: that corresponding item information of the one or more items to be sorted does not have a sorting destination corresponding to the item information.

In the above automatic logistics sorting method, that the one or more items to be sorted do not have the corresponding sorting destination information includes: that the one or more items to be sorted has not recorded the item information relating to the corresponding sorting destination.

In the above automatic logistics sorting method, that the one or more items to be sorted do not have the corresponding sorting destination information includes: that the item information recorded on the one or more items to be sorted is unidentifiable.

In the above automatic logistics sorting method, the abnormality information of the one or more items to be sorted includes that the one or more items to be sorted have multiple pieces of corresponding sorting destination information, and the step of further processing the abnormal item includes: recording the abnormality information of the one or more items to be sorted; and identifying one of the multiple pieces of sorting destination information of the one or more items to be sorted to re-sort the one or more items to be sorted.

In the above automatic logistics sorting method, the step that the abnormality sorting target object for abnormality processing is set includes: determining the number of abnormal sorting objects for the abnormality processing and/or positions of the abnormal sorting objects for the abnormality processing in the item dropping area according to quantitative proportions of the one or more items to be sorted corresponding to different sorting target objects.

In the above automatic logistics sorting method, the sorting target objects correspond to moveable containers for containing sorted items.

It will be understood by those skilled in the art that other details of the automatic logistics sorting method in the embodiment of the present application are the same as the corresponding details previously described in the automatic logistics sorting system in the above embodiment of the present application, and will not described again to avoid redundancy.

It will be understood by those skilled in the art that in the automatic logistics sorting method in the embodiment of the present application, the abnormal item to be sorted is regarded as an item to be sorted corresponding to a specific sorting target object for abnormality processing different from a general sorting target object. That is, the abnormality processing is regarded as a sorting destination of a particular type.

Therefore, in the above automatic logistics sorting method, the step that the item related information of the one or more items to be sorted is acquired specifically includes: acquiring the abnormality information of the one or more items to be sorted; and the step that specific sorting target objects corresponding to the one or more items to be sorted are determined based on the item related information includes: determining specific sorting target objects corresponding to the one or more items to be sorted based on the abnormality information.

Specifically, in the item supplying area, one or more items to be sorted such as packages may be manually or automatically placed on the automatic transport unit. The automatic transport unit may be a robot for carrying the package to be sorted, and the package to be sorted may be placed on the carrying device of the robot.

The automatic transport unit may enter the inspection entrance for the item to be sorted, and the item related information about the sorting destination of the item to be sorted is acquired by the item inspection device. For example, the item inspection device may be a scanning device for scanning a manifest on the package to obtain destination information of the package.

The control device determines a correspondence between the destination of the package and the sorting target object of the item dropping area through the destination information of the package. The correspondence between the destination of the package and the sorting target object may be any one of one-to-one, multiple-to-one, one-to-multiple, and multiple-to-multiple. Based on the correspondence and scheduling logic, the control device may determine a sorting target object to which the automatic transport unit carrying a specific item to be sorted is going to travel.

In the transport area, the control device may further control the automatic transport unit to travel to a corresponding sorting target object and drop the item so as to complete a single sorting task. In addition, if the automatic transport unit carries other items to be sorted that need to be transported to different sorting target objects, the control device continues to control the automatic transport unit to travel to a next sorting target object until the delivery of all items to be sorted is completed.

The control device may control the automatic transport unit to return to the item supplying area and continue to perform another item sorting task.

It will be understood by those skilled in the art that the control device may be an overall control device disposed in the automatic logistics sorting system, and is configured to communicate with the automatic transport unit in a manner of, for example, wireless communication to control the movement and item dropping of the automatic transport unit. In addition, the control device may also be disposed in each automatic transport unit, so as to control the movement and item dropping of each automatic transport unit.

In addition, in the automatic logistics sorting method in the embodiment of the present application, the step that the automatic transport unit carries the item to be sorted to pass through the transport area further includes: determining whether a state of charge of the automatic transport unit is less than a preset threshold; and in response to determining that the state of charge of the automatic transport unit is less than the preset threshold, controlling the automatic transport unit to travel to a preset charging position.

In the automatic logistics sorting method in the embodiment of the present application, the step that the automatic transport unit carries the item to be sorted to pass through the transport area further includes: navigating the automatic transport unit to pass through the transport area by using a two-dimensional code.

Automatic Logistics Sorting System Having a Mechanism for Automatically Processing a Fault of an Automatic Transport Unit

Since the automatic transport unit may have a fault, the above automatic logistics sorting system may further include a mechanism for automatically processing a fault of an automatic transport unit.

That is, according to an aspect of the present application, in the above automatic logistics sorting system, a control system, for example, the control device 220 illustrated in FIG. 3, further includes a fault processing device. The fault processing device includes: a detecting unit, which is configured to detect a state of the automatic transport unit; a determining unit, which is configured to determine a state type of the automatic transport unit; and a control unit, which is configured to, in response to determining that the automatic transport unit is in a first state type where an automatically fixable fault occurs, control the automatic transport unit to automatically fix the fault.

FIG. 6 is a block diagram of a fault processing device according to an embodiment of the present application. As illustrated in FIG. 6, the fault processing device 600 in the embodiment of the present application includes: a detecting unit 601, which is configured to detect a state of the automatic transport unit 210, 610; a determining unit 602, which is configured to determine a type of the state of the automatic transport unit 210, 610 detected by the detecting unit 601; and a control unit 603, which is configured to, in response to the determining unit 602 determining that the automatic transport unit 210, 610 is in a first state type where an automatically fixable fault occurs, control the automatic transport unit 210, 610 to automatically fix the fault.

In the automatic logistics sorting system, after the fault of the automatic transport unit is detected by detecting the state of the automatic transport unit, a fault type of the automatic transport unit is further determined, and the automatic transport unit is automatically processed according to different fault types of the automatic transport unit, thereby implementing the efficient item sorting.

Of course, it will be understood by those skilled in the art that the automatic logistics sorting system in the embodiment of the present application may not only cope with the fault of the automatic transport unit, but also cope with other situations which are not related to the fault of the automatic transport unit, such as a low battery state of the automatic transport unit described below and an abnormal state of the item to be sorted carried by the automatic transport unit, such as the item dropping, etc. Therefore, the present application is not intend to limit the fault processing device in the automatic logistics sorting system in the embodiments of the present application to only process the fault of the automatic transport unit.

Specifically, the automatic logistics sorting system in the embodiment of the present application determines whether the automatic transport unit has an automatically fixable fault, such as a network fault, like disconnection of the network connected to the control system. The inventor of the present application found that, in the automatic logistics sorting system, since the automatic transport unit needs to move in the sorting area to transport the item to be sorted, the disconnection to the system network is common, which causes a fault that the system signal cannot be received. Such a fault may often be automatically repaired by the automatic transport unit, such as re-sending a request signal for the network connection to the control system. In the process of automatically repairing the fault, the movement of the automatic transport unit may not be affected. For example, the automatic transport unit may still continue to move in accordance with the route previously received from the control system until the network is reconnected. Therefore, for such a fault, the automatic logistics sorting system in the embodiment of the present application controls the automatic transport unit to automatically fix the fault, thereby not affecting the overall operation efficiency of the automatic logistics sorting system.

In the process of automatically repairing the fault, the movement of the automatic transport unit may not be affected. For example, the automatic transport unit may still continue to move in accordance with the route previously received from the control system until the network is reconnected.

In the above automatic logistics sorting system, the determining unit is further configured to, in response to determining that the automatic transport unit is not in the first state type where the automatically fixable fault occurs, determine whether the automatic transport unit is in a second state type where a not automatically fixable fault occurs but the movement of the automatic transport unit is not affected; and the control unit is further configured to, in response to determining that the automatic transport unit is in the second state type, control the automatic transport unit to move to a specific position.

Specifically, the automatic logistics sorting system in the embodiment of the present application determines whether the automatic transport unit has a fault which does not affect the movement of the automatic transport unit, that is, the automatic transport unit may still be able to move even if the automatic transport unit has a fault. The automatic transport unit having the fault is first moved to a specific position, such as a pre-defined specific area in the sorting site, and the fault of the automatic transport unit is processed. Typically, in order not to affect the movement of other automatic transport units, the specific position may be located in the item dropping area. Therefore, even if the automatic transport unit has a fault, the movement of other automatic transport units in the system is not affected, so as not to affect the overall operation of the system, and avoid the influence of a single automatic transport unit having a fault on the whole system.

In the automatic logistics sorting system in the embodiment of the present application, the specific position in the sorting site, to which the automatic transport unit having a fault moves, may be determined based on multiple factors. For example, one or more specific areas for processing the fault may be set in an area where automatic transport units are not dense in the sorting area. Therefore, in one aspect, the route planning of other automatic transport units is not be hindered, and in another aspect, the automatic transport units having a fault are navigated to the specific areas with the least crosses with other automatic transport units.

It will be understood by those skilled in the art that the automatic transport unit mentioned in the automatic logistics sorting system in the embodiment of the present application may be a robot, or may be another moveable unit which implements the item sorting by transporting the item, and the present application is not intended to limit the type of the automatic transport unit.

Regardless of the type of automatic transport unit, the automatic logistics sorting system in the embodiment of the present application defines different types of fault processing modes, thereby avoiding the influence of the fault of a single automatic transport unit on the overall operation of the system, thereby achieving a high operation efficiency of the entire sorting system.

For the automatic logistics sorting system using the automatic transport unit, the faults of the automatic transport unit which do not affect the movement mainly include the following types:

Item dropping down: in the process of the automatic transport unit transporting the item, the automatic transport unit may determine through its sensor whether the item is dropped down, and automatically lock current coordinates; and in addition, the automatic transport unit may further indicate the fault by way of its indicator light. In a case where the item is dropped down, the coordinates of a position where the item is dropped down in the sorting site may be identified, so that the routes of other automatic transport units may be designed to make them avoid the dropped items.

Item dropping fault: since the item may be normally dropped within 3 seconds when the automatic transport unit drops the item, the system may perform the detection according to item dropping time, and if the item fails to be dropped for more than 5 seconds, it means that there is an item dropping fault.

Item supplying fault: when the item is supplied, in the automatic transport unit providing large-sized item sorting, if the automatic transport unit detects that the number of carried items is different from the number of items indicated in a service system, the system will feed back this abnormality.

Therefore, in the above automatic logistics sorting system, the first state type includes one of: that the automatic transport unit detects that the transported item to be sorted is dropped down; that the automatic transport unit detects that the item dropping duration of the item to be sorted exceeds a preset time threshold; that the automatic transport unit detects that the number of transported items to be sorted is different from the previously set number; or that the automatic transport unit detects that it is unable to receive an external instruction.

The common feature of above faults is that they do not affect the movement of the automatic transport units in the sorting site. At this moment, if the automatic transport unit stays in the place where the fault occurs, the movement of other automatic transport units will be affected. Therefore, the influence on the movement of other automatic transport units may be avoided by moving the automatic transport unit to the specific position.

After the automatic transport unit is moved to the specific position, the automatic transport unit having the fault may be separately processed, or after the number of automatic transport units having the fault reaches a certain number, the automatic transport units having the fault may be collectively processed.

In addition, in the automatic logistics sorting method in the embodiment of the present application, other fault types may exist, which will be described below.

In the above automatic logistics sorting system, the determining unit is further configured to determine whether the automatic transport unit is in a third state type where from the automatic transport unit deviates from a normal travel route; and the control unit is further configured to, in response to determining that the automatic transport unit is in the third state type, control the automatic transport unit to correct the travel route.

That is, when detecting a fault that the mobile unit deviates from the planned route, the travel route of the mobile unit may be re-determined based on the overall route plan, so that the automatic transport unit may complete the item transportation based on the corrected travel route.

In the above automatic logistics sorting system, the determining unit is further configured to determine whether the automatic transport unit is in a fourth state type where the automatic transport unit needs to be charged; and the control unit is further configured to, in response to determining that the automatic transport unit is in the fourth state type, control the automatic transport unit to travel to a preset charging position.

That is, the automatic transport unit may detect the state of charge of the automatic transport unit itself. When the state of charge is insufficient, the charging position is typically set as the destination of the travel route, and the route is re-planed after the charging is completed so as to complete the item transportation.

In addition, the automatic transport unit still has the fault which makes the automatic transport unit not move, the automatic logistics sorting method in the embodiments of the present application may also need a mechanism to cope with the fault.

In the above automatic logistics sorting system, the determining unit is further configured to determine whether the automatic transport unit is in a fifth state type where a fault occurs and the automatic transport unit is unable to move; and the control unit is further configured to, in response to determining that the automatic transport unit is in the fifth state type, determine a position of the automatic transport unit and determine a disabled area according to the position.

In the above automatic logistics sorting system, the control system further includes stop all automatic transport units in the disabled area from moving, and control a travel route of an automatic transport unit moving outside the disabled area to make the automatic transport unit avoid the disabled area.

That is, when the automatic transport unit or the control system determines that the automatic transport unit has a fault and fails to travel to the specific fault processing area in accordance with the instruction, an area in the sorting site needs to be locked manually. All automatic transport units in the locked area stop moving, and automatic transport units outside the locked area cannot enter the locked area, so that the fault of the automatic transport unit may be processed through manual intervention. After the fault is processed, the locked area may be unlocked, so that the logistics sorting in the whole site may be recovered.

It will be understood by those skilled in the art that, when a serious fault occurs, the whole site may be locked, so as to avoid damage to other automatic transport units and the transported items due to the fault of the automatic transport unit.

As mentioned above, the fault that the item to be sorted transported by the automatic transport unit is dropped down may occur, at this moment, the automatic transport unit should report the position where the item is dropped down for further processing.

That is, in the above automatic logistics sorting system, the determining unit is further configured to determine whether the automatic transport unit is in a sixth state type where the item to be sorted is abnormal; and the control unit is further configured to, in response to determining that the automatic transport unit is in the sixth state type, control the automatic transport unit to stop moving and send its current position information to the control system for further processing.

When the automatic transport unit waits for unloading and transporting the dropped item, it will stay in the position where the fault occurs, so a fault point will occur in the system. Therefore, the control system should mark this position, and re-plan travel routes of other automatic transport units.

In the above automatic logistics sorting system, the control system is further configured to re-plan travel routes of other automatic transport units based on the current position information.

Of course, it will be understand by those skilled in the art that other automatic transport units may be automatically navigated to avoid this fault point according to the fault marked by the control system.

In the logistics sorting system, the fault is mainly divided into two types, that is, the system fault and the hardware fault. The system fault refers to a state in which the system cannot perform a specified function. That is, the system stops running due to some reason during the operation of the system, so that the sorting in the entire sorting site cannot be performed normally and the state of the automatic transport unit and the item is lost. The hardware fault refers to that the automatic transport unit cannot work normally. For example, the automatic transport unit described above cannot be driven by the sorting system, deviates from the route due to the large navigation error, and so on. For such a fault, if manual intervention is performed every time a fault occurs, since people need to enter the sorting site to manually process the fault, the corresponding area where the fault occurs and the route to the corresponding area must be disabled, thereby significantly affecting the overall operation of the system.

Especially, for the current logistics sorting system, in order to improve the operational efficiency of the system, the automatic transport unit represents features of a large quantity and a high speed. The manual intervention in the fault must be reduced as much as possible in terms of system operation efficiency and personnel safety. Therefore, the automatic logistics sorting system in the embodiment of the present application is provided on the basis of the background, so that it may applicable to the current large-scale logistics sorting system.

In addition, although the fault processing mechanism in the embodiments of the present application is described as a part of the control system of the automatic logistics sorting system, it may also be a separate control device. When combined with the control system in the automatic logistics sorting system, the fault processing mechanism may be a functional module of the control system.

It will be understood by those skilled in the art that the fault processing mechanism in the embodiment of the present application may be applied to various automatic logistics sorting systems, such as the automatic logistics sorting system in the form of “robot plus steel platform” shown in FIG. 1.

In addition, the fault processing mechanism in the embodiments of the present application may be applied to the automatic logistics sorting system with the layout described above.

That is, in the above automatic logistics sorting system, the sorting area further includes: an item supplying area, which is configured to distribute the item to be sorted; a transport area, which is configured to allow one or more automatic transport units to move therein, where the one or more automatic transport units are configured to transport the item to be sorted to pass through the transport area; and an item dropping area, which includes a plurality of sorting target objects, where the one or more automatic transport units are configured to drop the item to be sorted to a corresponding sorting target object in the item dropping area. The transport area and the item dropping area are located on the same plane and do not overlap.

In addition, the automatic logistics sorting controlling method and device in the embodiments of the present application may be applied to other automatic logistics sorting system with a different layout. Another example will be described in detail below.

An example of the automatic logistics sorting system in the embodiment of the present application will be described below. In the automatic logistics sorting system of this example, the item supplying area is in the form of an item supplying stand, and the package to be sorted is manually or automatically placed on a moving transport device. In addition, the automatic logistics sorting system in this example may include a package inspection entrance provided with a package inspection device. The package inspection device includes a package information acquiring device for acquiring package information of the package to be sorted entering the package inspection entrance corresponding to the package information acquiring device. The package information includes a destination of the package to be sorted, that is, the sorting target object described above. Typically, the package inspection entrance is disposed in the item supplying area.

The mobile transport device may be, for example, a robot. When moving in the transport section, the mobile transport device is configured to carry one or more packages to be sorted. The destination information of the package to be sorted is included in a destination information code. The destination information code is disposed on the package to be sorted, so that the mobile transport device may carry the package to a sorting destination.

In addition, the transport section may include a transport travelling platform. The transport travelling platform refers to a platform where the mobile transport device travels, and may be ground, a certain constructed platform, a track or the like.

An item dropping end is disposed at the peripheral edge of the transport section as the item dropping area. The item dropping end is provided with a package storage device. The mobile transport device travels to the item dropping end, and drops the package to be sorted into the package storage device at the item dropping end.

In addition, the automatic logistics sorting system in this example includes a control system interconnected to the package inspection device and the mobile transport device. The control system provides task or scheduling information for the mobile transport device based on the package related information, and controls the mobile transport device to complete the complete package sorting processes and tasks.

The control device 220 may further include a fault processing device. The fault processing device includes: a detecting unit, which is configured to detect a state of the automatic transport unit; a determining unit, which is configured to a state type of the automatic transport unit; and a control unit, which is configured to, in response to determining that the automatic transport unit is in a first state type where an automatically fixable fault occurs, control the automatic transport unit to automatically fix the fault.

In addition, as mentioned above, the automated logistics sorting system may itself include a control system to control the sorting of items to be sorted to respective sorting destinations.

That is, according to an exemplary embodiment of the present application, an automatic logistics sorting system is provided. The automatic logistics sorting system includes: an item supplying stand, which is configured to place an item to be sorted on an automatic transport unit; an item inspection device, which is configured to acquire item related information of the item to be sorted; a control device, which is configured to determine one or more sorting destinations corresponding to the item to be sorted based on the item related information; a transport area, which is configured to allow the control device to control the automatic transport unit to pass through the transport area to arrive the sorting destination; and an item dropping area, which includes the sorting destination and is configured to allow the automatic transport unit to drop the item to be sorted to the sorting destination. The transport area and the item dropping area are located on the same plane and do not overlap. The control device further includes: a detecting unit, which is configured to determine a state of the automatic transport unit; a determining unit, which is configured to determine a state type of the automatic transport unit; and a control unit, which is configured to, in response to determining that the automatic transport unit is in the first state type where an automatically fixable fault occurs, control the automatic transport unit to automatically fix the fault.

Of course, it will be understood by those skilled in the art that the item inspection device and the control device including a fault processing mechanism may be integrated into an overall control system to control the item sorting and the fault of the automatic transport unit overall.

That is, according to another exemplary embodiment of the present application, there is provided an automatic logistics sorting system which includes: an automatic transport unit, which is configured to transport an item to be sorted; a sorting area, which is configured to allow the automatic transport unit to operate therein to implement the sorting of the item to be sorted; and a control device, which is configured to control the sorting of the item to be sorted and movement of the automatic transport unit in the sorting area. The sorting area further includes: an item supplying area, which is configured to distribute the item to be sorted; a transport area, which is configured to allow one or more automatic transport units to move therein, where the one or more automatic transport units are configured to transport the item to be sorted to pass through the transport area; and an item dropping area, which includes multiple sorting target objects, where the one or more automatic transport units are configured to drop the item to be sorted to a corresponding sorting target object in the item dropping area. The transport area and the item dropping area are located on the same plane and do not overlap. The control system further includes an abnormal item processing device. The abnormal item processing device includes a fault processing device. The fault processing device includes: a detecting unit, which is configured to determine a state of the automatic transport unit; a determining unit, which is configured to determine a state type of the automatic transport unit; and a control unit, which is configured to, in response to determining that the automatic transport unit is in the first state type where an automatically fixable fault occurs, control the automatic transport unit to automatically fix the fault.

Automatic Logistics Sorting Method Having a Mechanism for Automatically Processing a Fault of an Automatic Transport Unit

According to another aspect of the present application, there is provided an automatic logistics sorting method which includes: placing one or more items to be sorted on an automatic transport unit in an item supplying area; acquiring item related information of the one or more items to be sorted; determining a specific sorting target object corresponding to the one or more items to be sorted based on the item related information; carrying, by the automatic transport unit, the one or more items to be sorted to pass through a transport area; and moving, by the automatic transport unit, to an item dropping area, and dropping the one or more items to be sorted to a corresponding specific sorting target object. The automatic logistics sorting method further includes: detecting a state of the automatic transport unit; determining a state type of the automatic transport unit; and in response to determining that the automatic transport unit is in a first state type where an automatically fixable fault occurs, controlling the automatic transport unit to automatically fix the fault.

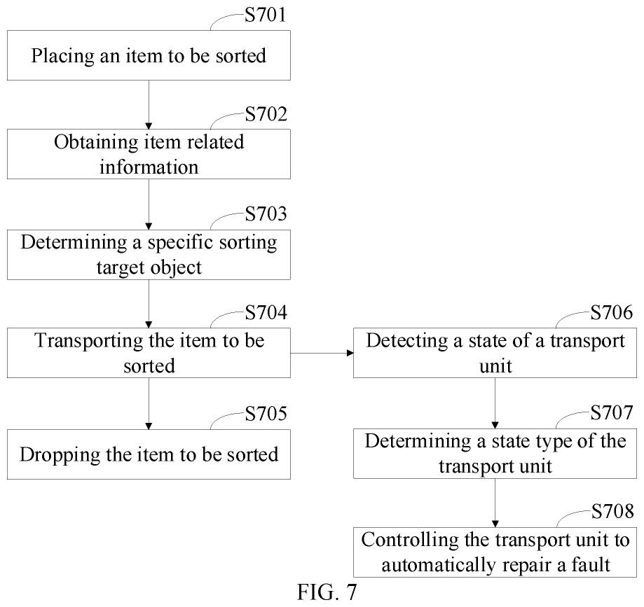

FIG. 7 is a flowchart of an automatic logistics sorting method according to an embodiment of the present application. As illustrated in FIG. 7, the automatic logistics sorting method in the embodiment of the present application includes steps described below. In step S701, one or more items to be sorted are placed on an automatic transport unit in an item supplying area. In step S702, item related information of the one or more items to be sorted is acquired. In step S703, specific sorting target objects corresponding to the one or more items to be sorted are determined based on the item related information. In step S704, the automatic transport unit carries the one or more items to be sorted to pass through a transport area. In step S705, the automatic transport unit moves to an item dropping area, and drops the one or more items to be sorted to a corresponding specific sorting target object. The automatic logistics sorting method further includes steps described below. In step S706, a state of the automatic transport unit is detected in the process of the step S704. In step S707, a state type of the automatic transport unit is determined. In step S708, in response to determining that the automatic transport unit is in a first state type where an automatically fixable fault occurs, the automatic transport unit is controlled to automatically fix the fault.

In the above automatic logistics sorting method, determining the state type of the automatic transport unit further includes: in response to determining that the automatic transport unit is not in the first state type where the automatically fixable fault occurs, determining whether the automatic transport unit is in a second state type where a not automatically fixable fault occurs but movement of the automatic transport unit is not affected; and the automatic logistics sorting method further includes: in response to determining that the automatic transport unit is in the second state type, control to move the automatic transport unit to a specific position.

In the above automatic logistics sorting method, the second state type includes one of: that the automatic transport unit detects that an execution duration of dropping the one or more items to be sorted exceeds a predetermined time threshold; that the automatic transport unit detects that the number of the transported one or more items to be sorted is different from the previously set number; or that the automatic transport unit detects that it is unable to receive an external instruction.

In the above automatic logistics sorting method, determining the state type of the automatic transport unit further includes: determining whether the automatic transport unit is in a third state type where from the automatic transport unit deviates from a normal travel route; and the automatic logistics sorting method further includes: in response to determining that the automatic transport unit is in the third state type, controlling the automatic transport unit to correct its travel route.

In the above automatic logistics sorting method, determining the state type of the automatic transport unit further includes: determining whether the automatic transport unit is in a fourth state type where the automatic transport unit needs to be charged; and the automatic logistics sorting method further includes: in response to determining that the automatic transport unit is in the fourth state type, controlling the automatic transport unit to travel to a preset charging position.

In the above automatic logistics sorting method, determining the state type of the automatic transport unit further includes: determining whether the automatic transport unit is in a fifth state type where a fault occurs and the automatic transport unit is unable to move; and the automatic logistics sorting method further includes: in response to determining that the automatic transport unit is in the fifth state type, determining a position of the automatic transport unit and determining a disabled area according to the position.

In the above automatic logistics sorting method, determining the position of the automatic transport unit specifically includes: stopping all automatic transport units in the disabled area from moving, and controlling a travel route of an automatic transport unit moving outside the disabled area to make the automatic transport unit avoid the disabled area.

In the above automatic logistics sorting method, determining the state type of the automatic transport unit further includes: determining whether the automatic transport unit is in a sixth state type where the one or more items to be sorted are abnormal; and the automatic logistics sorting method further includes: in response to determining that the automatic transport unit is in the sixth state type, controlling the automatic transport unit to stop moving and sending its current position information to a control system for further processing.

In the above automatic logistics sorting method, the automatic logistics sorting method further includes: re-planning travel routes of other automatic transport units based on the current position information.

In the above automatic logistics sorting method, the transport area and the item dropping area are located on the same plane and do not overlap.

Specifically, in the item supplying area, one or more items to be sorted such as packages may be manually or automatically placed on the automatic transport unit. The automatic transport unit may be a robot for carrying the package to be sorted, and the package to be sorted may be placed on the carrying device of the robot.

The automatic transport unit may enter the inspection entrance for the item to be sorted, and the item related information about the sorting destination of the item to be sorted may be obtained through the item inspection device. For example, the item inspection device may be a scanning device for scanning a manifest on the package to obtain destination information of the package.

The control device determines a correspondence between the destination of the package and the sorting target object of the item dropping area through the destination information of the package. The correspondence between the destination of the package and the sorting target object may be any one of one-to-one, multiple-to-one, one-to-multiple, and multiple-to-multiple. Based on the correspondence and scheduling logic, the control device may determine a sorting target object to which the automatic transport unit carrying a specific item to be sorted is going to travel.

In the transport area, the control device may further control the automatic transport unit to travel to a corresponding sorting target object and drop the item so as to complete a single sorting task. In addition, if the automatic transport unit carries other items to be sorted that need to be transported to different sorting target objects, the control device continues to control the automatic transport unit to travel to a next sorting target object until the delivery of all items to be sorted is completed.

The control device may control the automatic transport unit to return to the item supplying area and continue to perform another item sorting task.

If the automatic transport unit has a fault, the control device may perform steps S706 to S708 to implement the automatic fault repair of the automatic transport unit.

It will be understood by those skilled in the art that the control device may be overall general control device disposed in the automatic logistics sorting system, and is configured to communicate with the automatic transport unit in e.g. a wireless manner so as to control the movement, the item dropping and the fault processing of the automatic transport unit. In addition, the control device may also be disposed in each automatic transport unit, so as to control the movement, the item dropping and the fault processing of each automatic transport unit.

In addition, in the automatic logistics sorting method in the embodiment of the present application, the step that the automatic transport unit carries the item to be sorted to pass through the transport area further includes: navigating the automatic transport unit to pass through the transport area by using a two-dimensional code.

It is to be understood by those skilled in the art that the embodiments of the present application described in the above description and drawings are by way of example only and not intended to limit the present application. The purpose of the present application has been completely and efficiently achieved. The function and structural principle of the present application have been shown and illustrated in the embodiments, and the embodiments of the present application may be altered or modified without departing from the principle.

1. An automatic logistics sorting system, comprising:
an automatic transport unit, configured to transport an item to be sorted;
a sorting area, configured to allow the automatic transport unit to operate therein to implement sorting of the item to be sorted, the sorting area comprising an item dropping area which comprises a plurality of sorting target objects, the automatic transport unit being configured to drop the item to be sorted into a corresponding sorting target object in the item dropping area; and
a control system, configured to control the sorting of the item to be sorted and control movement of the automatic transport unit in the sorting area, the control system comprising:
a setting unit, configured to set a specific sorting target object among the plurality of sorting target objects for abnormality processing;
a determining unit, configured to determine whether the item to be sorted is abnormal; and
a control unit, configured to, in response to determining that the item to be sorted is abnormal, control to transport the item to be sorted to the specific sorting target object for abnormality processing.

2. The automatic logistics sorting system of claim 1, wherein the sorting area further comprises:
an item supplying area, configured to distribute the item to be sorted; and
a transport area, configured to allow one or more of the automatic transport unit to move therein, wherein the one or more automatic transport units are configured to transport the item to be sorted to pass through the transport area;
wherein the transport area and the item dropping area are located on a same plane and do not overlap.

3. The automatic logistics sorting system of claim 2, wherein the control system further comprises at least one selected from the group consisting of the following:
a first processing unit, configured to process an abnormal item in the item supplying area; and
a second processing unit, configured to process the abnormal item in the specific sorting target object configured for abnormality processing.

4. The automatic logistics sorting system of claim 3, wherein the determining unit is configured to:
determine whether the item to be sorted has no corresponding sorting destination information; and
the second processing unit is configured to:
re-determine a sorting destination of the item to re-sort the item.

5. The automatic logistics sorting system of claim 4, wherein the determining unit is configured to:
determine that the corresponding item information of the item to be sorted does not comprise a sorting destination corresponding to the item information; or
determine whether the item to be sorted has not recorded the item information relating to the corresponding sorting destination; or
determine whether the item information recorded on the item to be sorted is unidentifiable.

6. The automatic logistics sorting system of claim 3, wherein
the determining unit is configured to determine whether the item to be sorted has a plurality of pieces of corresponding sorting destination information; and
the second processing unit is configured to record abnormality information of the item to be sorted, and identify one of the plurality of pieces of sorting destination information of the item to be sorted to re-sort the item.

7. The automatic logistics sorting system of claim 3, wherein the setting unit is further configured to determine a number of the specific sorting target object configured for the abnormality processing and/or positions of the specific sorting target objects in the item dropping area based on quantitative proportions of the items to be sorted corresponding to different sorting target objects.

8. The automatic logistics sorting system of claim 1, wherein the plurality of sorting target objects correspond to moveable containers configured for containing sorted items.

9. An automatic logistics sorting method, comprising:
placing one or more items to be sorted on an automatic transport unit in an item supplying area;
obtaining item related information of the one or more items to be sorted, the item related information comprising abnormality information of the one or more items to be sorted;
configuring an abnormality sorting target object for abnormality processing;
determining a specific sorting target object corresponding to the one or more items to be sorted based on the item related information, wherein the one or more items to be sorted having the abnormality information corresponds to the abnormality sorting target object configured for abnormality processing;
carrying, by the automatic transport unit, the one or more items to be sorted to pass through a transport area, wherein the one or more items to be sorted having the abnormality information is transported to the abnormality sorting target object configured for abnormality processing; and
moving, by the automatic transport unit, to an item dropping area, and dropping the one or more items to be sorted to a corresponding specific sorting target object.

10. The automatic logistics sorting method of claim 9, wherein the transport area and the item dropping area are located on a same plane and do not overlap.

11-16. (canceled)

17. An automatic logistics sorting system, comprising:
an automatic transport unit, configured to transport an item to be sorted;
a sorting area, configured to allow the automatic transport unit to operate therein to implement sorting of the item to be sorted; and
a control system, configured to control the sorting of the item to be sorted and movement of the automatic transport unit in the sorting area, the control system comprising:
a detecting unit, configured to detect a state of the automatic transport unit;
a determining unit, configured to determine a state type of the automatic transport unit; and
a control unit, configured to, in response to determining that the automatic transport unit is in a first state type where an automatically fixable fault occurs, control the automatic transport unit to automatically fix the fault.

18. The automatic logistics sorting system of claim 17, wherein the determining unit is further configured to:
in response to determining that the automatic transport unit is not in the first state type where the automatically fixable fault occurs, determine whether the automatic transport unit is in a second state type where a not automatically fixable fault occurs but the movement of the automatic transport unit is not affected; and
the control unit is further configured to:
in response to determining that the automatic transport unit is in the second state type, control to move the automatic transport unit to a specific position.

19. The automatic logistics sorting system of claim 18, wherein the second state type comprises one of:
that the automatic transport unit detects that an execution duration of dropping the item to be sorted exceeds a predetermined time threshold;
that the automatic transport unit detects that a number of the transported items to be sorted is different from a previously set number; or
that the automatic transport unit detects that it is unable to receive an external instruction.

20. The automatic logistics sorting system of claim 17, wherein the determining unit is further configured to:
determine whether the automatic transport unit is in a third state type where the automatic transport unit deviates from a normal travel route; and
the control unit is further configured to:
in response to determining that the automatic transport unit is in the third state type, control the automatic transport unit to correct the travel route of the automatic transport unit.

21. The automatic logistics sorting system of claim 17, wherein the determining unit is further configured to:
determine whether the automatic transport unit is in a fourth state type where the automatic transport unit needs to be charged; and
the control unit is further configured to:
in response to determining that the automatic transport unit is in the fourth state type, control the automatic transport unit to travel to a preset charging position.

22. The automatic logistics sorting system of claim 17, wherein the determining unit is further configured to:
determine whether the automatic transport unit is in a fifth state type where a fault occurs and the automatic transport unit is unable to move; and
the control unit is further configured to:
in response to determining that the automatic transport unit is in the fifth state type, determine a position of the automatic transport unit and determine a disabled area according to the position.

23. The automatic logistics sorting system of claim 22, wherein the control unit is further configured to:
stop all automatic transport units in the disabled area from moving; and
control a travel route of an automatic transport unit moving outside the disabled area to make the automatic transport unit avoid the disabled area.

24. The automatic logistics sorting system of claim 17, wherein the determining unit is further configured to:
determine whether the automatic transport unit is in a sixth state type where the item to be sorted is abnormal; and
the control unit is further configured to:
in response to determining that the automatic transport unit is in the sixth state type, control the automatic transport unit to stop moving and send its current position information to the control system for further processing.

25. The automatic logistics sorting system of claim 24, wherein the control system is further configured to re-plan travel routes of other automatic transport units based on the current position information.

26. The automatic logistics sorting system of claim 17, wherein the sorting area further comprises: an item supplying area, configured to distribute the item to be sorted; a transport area, configured to allow one or more automatic transport units to move therein, wherein the one or more automatic transport units are configured to transport the item to be sorted to pass through the transport area; and an item dropping area, which comprises a plurality of sorting target objects, wherein the one or more automatic transport units are configured to drop the item to be sorted into a corresponding sorting target object in the item dropping area; wherein the transport area and the item dropping area are located on a same plane and do not overlap.

27-36. (canceled)
